(19) United States
(12) Patent Application Publication
(10) Pub. No.: US 2016/0250797 A1
(43) Pub. Date: Sep. 1, 2016

(54) MOLDING UNIT FOR THE MANUFACTURE OF CONTAINERS COMPRISING A COMPENSATION GRIPPER

(71) Applicant: SIDEL PARTICIPATIONS, Octeville Sur Mer (FR)

(72) Inventors: Jocelyn MICHEL, Octeville Sur Mer (FR); Frederic LECOMTE, Octeville Sur Mer (FR); Patrice ANDREUX, Octeville Sur Mer (FR); Michel DAUDIGNY, Octeville Sur Mer (FR)

(21) Appl. No.: 15/028,643

(22) PCT Filed: Oct. 9, 2014
(86) PCT No.: PCT/EP2014/071646

§ 371 Date: Apr. 11, 2016

(30) Foreign Application Priority Data
Oct. 14, 2013 (FR) 1359950

(51) Int. Cl. B29C 49/30

(52) U.S. Cl. CPC B29C 49/30

(57) ABSTRACT

A molding unit (10) for the manufacture of containers from preforms made of thermoplastic, includes compensating elements which are formed of at least one gripper (60) which acts on mold carriers (16) that carry the mold (12) of the unit (10) in order to clamp them against one another when the molding unit (10) is in the closed position and to apply a compensating force that tends to clamp together molding elements (14) of the mold (12) at a parting line (P) and opposes the forces that a pressurized fluid applies to the molding elements (14) when a container is being molded from a preform.

The invention relates to a molding unit for the manufacture of containers comprising a compensation gripper.

The invention relates more particularly to a molding unit for the manufacture of containers from preforms made of thermoplastic material, with said molding unit comprising at least:
A frame that carries a mold that comprises at least two molding elements each respectively mounted in an associated mold carrier,
At least one of said mold carriers being mounted to move in rotation in relation to the other around a vertical axis of rotation between an open position and a closed position of the mold in which said molding elements are mated with one another by respective support faces defining a longitudinally-oriented vertical parting line and together delimit a molding cavity;
Forming means for introducing at least one pressurized fluid inside the preform for the purpose of molding the corresponding container in the cavity,
A control mechanism of the opening and the closing of the mold for controlling the movement of at least one of the mold carriers between said open and closed positions of the mold,
And selectively controlled compensation means for applying a compensation force, tending to clamp the molding elements against one another in the area of said parting line and to oppose the forces that the pressurized fluid applies on the molding elements during the molding of a container from a preform.

A molding unit of this class that is intended to be mounted on a machine (also called “blower”) and used for the manufacture of containers from preforms made of thermoplastic material is also known from the state of the art.

The manufacture of containers (bottles, flasks, jars, etc.) made of thermoplastic material such as PET (polyethylene terephthalate) is done in such a molding unit by forming a hot preform at least by means of at least one pressurized fluid introduced through its neck inside the preform.

The forming of a container from a hot preform is achieved in particular by blow molding or by stretch blow molding by using, for example, air as a pressurized fluid.

A preform made of thermoplastic material that is intended for the manufacture of a container is obtained by injection molding, and then the injected preform is subsequently conditioned thermally, in general in a furnace, so as to obtain a hot preform that can undergo the forming operation.

As a variant, the hot preform is obtained by extrusion, and the forming operation is advantageously implemented in a molding unit directly at the end of its manufacture.

By way of nonlimiting example, it will be possible to refer to the document WO-99/03667, which describes an installation for the manufacture of sterile containers.

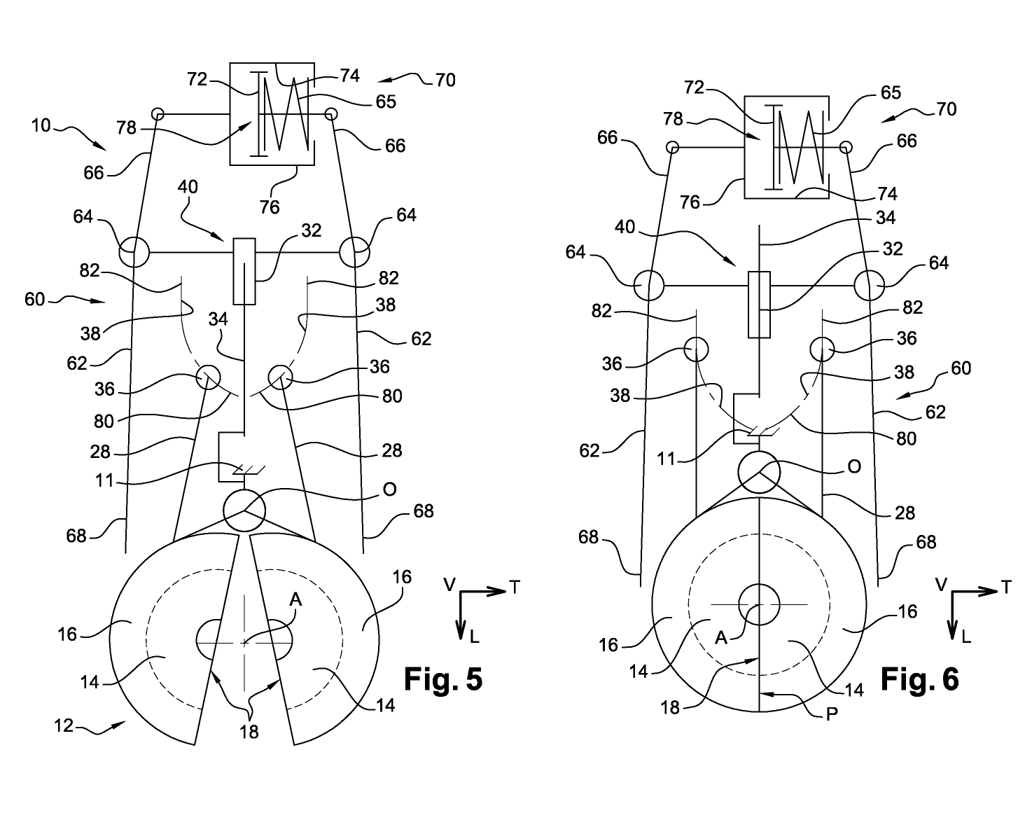

FIG. 5 of the document more particularly shows an installation that comprises a machine (or “blower”) that is equipped with multiple molding units that are distributed circumferentially over the entire periphery of a carrousel of the machine, with said carrousel being driven by a rotational movement around a vertical shaft that forms the main axis of the machine.

In this example, the manufacture of a container is achieved from a hot preform whose body is thermally conditioned in advance in a furnace, and then the body of the preform is inserted inside the mold of one of the molding units by transfer means. The compressed blow molding air is then introduced inside the preform through the neck to form a container corresponding to the molding cavity that the mated molding elements delimit.

The pressures involved during the blow molding of the container are particularly high, reaching—according to the applications—values that can range up to 30 or 40 bars.

The result is that by flattening the wall of the body of the preform against the impression of the molding cavity during the blow molding, the compressed air then applies significant forces on the surface of the impression of each of the molding elements.

This is one of the reasons for which the molding unit is provided with a locking device whose locking means are, in the locked position, capable of keeping the mold carriers in the closed position during the molding of the container by blow molding or by stretch blow molding.

The means for locking the mold in the closed position always exhibit, however, operational play. The existence of such operational play of the locking means and the forces applied on the molding elements by the pressurized fluid during the blow molding of the container cause the two molding elements to separate from one another and cause play to develop.

Thus, the separation of the molding elements, which is allowed by the locking means within the limits of operational play and is produced by the forces applied by compressed air introduced into the molding cavity, leads to the development of play in the area of the parting line between the molding elements, which play at best is created during the blow molding and at worst increases because there is also operational play resulting from the mounting of the molding elements in the mold carriers.

However, the development of such play or an opening between the two molding elements during forming is a problem that has an impact on the quality of the final container that is obtained.

The primary impacts are, on the one hand, the mechanical strength of the final container that is affected in the area of the parting line and, on the other hand, the esthetics of the final container with a visual defect consisting of the presence in the area of said parting line of a characteristic “feature” on the container.

This problem also has an impact on the molding unit, more particularly on the mold carriers that carry the molding elements that are subjected to significant mechanical deformations because of the presence of such play.

To solve this problem, a known solution of the state of the art consists in reducing at least the development of this play between the molding elements to equip the molding unit with so-called compensation means, formed by a chamber.

The compensation chamber is a variable-volume airtight chamber that is inserted between just one of the molding elements and the associated mold carrier.

The operation of such a compensation chamber will be recapped below. For further details on such a solution, it will be possible, for example, to refer to the documents FR-2,659,265 or EP-1,880,826 that are provided, however, in a non-limiting manner for illustrating the state of the art.

The compensation chamber is intended to be supplied selectively with compressed air according to a compensation cycle that is synchronized with the manufacture of the container.

During the manufacture of a container, the compensation is implemented after the molding unit is closed and locked and before the container is molded.

As recapped above, the forming of the container is done in particular by blow molding (or by stretch blow molding) of a hot preform by means of a pressurized blow molding fluid, which fluid in general consists of air.

As a variant, the forming is carried out, with or without stretching, at least in part by a pressurized liquid, such as the liquid that is intended to be conditioned in the manufactured container.

The pressurization of the compensation chamber is achieved by supplying it with compressed air. Under the action of the pressure, the result is an expansion of the compensation chamber inserted between the molding element and the mold carrier that causes a relative movement of the molding element in relation to the mold carrier.

The expansion of the compensation chamber tends to separate the mold carriers from one another, to open the molding unit. However, the mold carriers are kept in the closed position of the unit by locking means.

Thanks to the locking means, the force that results from the pressurization of the compensation chamber will therefore primarily be applied by reaction to the adjacent molding element that is thrust in the direction of the other molding element located opposite.

The compensation force resulting from the pressurization of the chamber consequently tends to clamp said molding elements against one another in the area of the parting line.

A first effect of the applied compensation force is therefore to eliminate—between the support faces of the molding elements—any play that previously was able to exist in the area of the parting line.

Thus, the compensation makes it possible to make up for the play between the molding elements in the area of the parting line delimited by the support faces of the molding elements around the molding impression that is recessed and that corresponds to the container.

This first compensation effect continues provided that during the blow molding of the container, the thrust force applied by the compressed air contained in the compensation chamber is greater than the forces applied by the blow molding air on the surface of the molding cavity.

The compensation force that is achieved is primarily determined by the surface of the compensation chamber and the air pressure that is introduced therein, and the necessary compensation force is in particular a function of the surface of the molding cavity and the blow molding pressure.

The pressure values of the air used for the compensation chamber are therefore high, up to 40 bars, as are those of the blow molding air used for molding the container.

When the compensation chamber is pressurized, the compensation force opposes the forces in the opposite direction that the pressure of the blow molding air of the preform applies to the cavity and that tend to separate the molding elements from one another again.

The second effect of the applied compensation force is therefore that of a counter-force that is capable of opposing the forces applied by the blow molding air and by so doing limiting, and even preventing, play from developing between the molding elements in the area of the parting line.

In a molding unit that comprises a compensation chamber, the compensation force that results from the pressurization is applied to the outside face of the molding element, or the face opposite to the impression that forms the cavity. The thrust force is applied to the surface of the face in contact with the compensation chamber.

Once the container is formed, the compensation cycle is completed by creating a leak for returning the compensation chamber to atmospheric pressure and for allowing the unlocking and then the opening of the mold so as to extract from it the manufactured container.

Thanks to such a compensation chamber, the quality of the manufactured final container is improved by reducing, at the very least, the play between the molding elements in the area of the parting line in such a way that said molding elements are contiguous and their respective faces are adjacent, most particularly during the molding of the container.

However, such a solution is not fully satisfactory and has drawbacks.

The integration of such a compensation chamber with a molding unit is not always easy and ultimately proves very costly. Its installation poses problems of maintenance cost for ensuring the reliability of the seal.

The implementation of the compensation cycle also has an impact on the manufacturing rates reached on a machine.

The use of compressed air as a compensation fluid and its being exhausted after each cycle for manufacture of a container is reflected in a significant consumption of energy to obtain the compressed air, in particular because of the compressible nature of air.

The compensation chamber also produces significant mechanical stresses both on the locking means and on the mold carriers of the molding unit.

Such mechanical stresses consequently require particular attention during the design and selection of the materials for limiting the deformations.

The object of this invention is in particular to eliminate the above-mentioned drawbacks and to propose a new solution that makes it possible to carry out—in a simple, economical and reliable manner—the compensation function in a unit for molding containers from preforms that are made of thermoplastic material.

For this purpose, the invention proposes a molding unit of the type described above, characterized in that the compensation means are formed by at least one gripper that acts on the mold carriers to clamp them against one another in the closed position of the molding unit and to apply said compensation force.

The compensation force applied by the gripper makes it possible, on the one hand, to eliminate, in the area of the parting line, the presence of any play between the molding elements by clamping one of the mold carriers against the other and, on the other hand, with said compensation force being greater than the forces applied by the compressed air on the molding elements, to keep them adjacent and contiguous during the forming of the container from the preform without play being able to develop in the area of the parting line.

By comparison with a compensation chamber according to the state of the art, said at least one compensation gripper acts directly on the mold carriers and no longer on one of the molding elements.

Advantageously, the compensation force is applied by the gripper in the direction of the parting line and in a symmetrical manner on each of the mold carriers. This compensation force is therefore a thrust force that is applied along a median transverse plane that is orthogonal to the parting line and that preferably passes through the primary axis of the mold.

Advantageously, the compensation means are mated with the molding unit and, by comparison with a compensation chamber, the molding elements that are intended to be mounted there are then identical to one another and independent since said molding elements are no longer directly involved in the implementation of the compensation function.

The compensation means formed by the gripper remain permanently mated with the mold carriers of a molding unit while the molding elements of a given unit are themselves able to be changed based on the container to be manufactured.

Because the compensation means are mated with the molding unit, both the design and the manufacture of the molding elements intended to be mounted there are simplified, and their assembly and disassembly times within the unit are also shortened.

Advantageously, the compensation function is produced at minimum cost since the compensation means equip a molding unit and no longer each of the molding elements that can be mounted there to manufacture different containers.

Advantageously, the energy consumption for carrying out the pressurization of the fluid in the actuating means mated with the compensation gripper is less than that of a compensation chamber.

Advantageously and by comparison with a pressure chamber, the compensation force applied by the clamp is achieved in a simple and precise manner by controlling in particular the pressure of the fluid that supplies the actuating means, making it possible in particular to vary the force and to adapt it for each container manufactured with a given blow molding pressure and a determined capacity.

Advantageously, the compensation means also ensure the locking function of the mold carriers in the closed position of the unit.

Thanks to the dual function of compensation and locking ensured by the compensation means, the conventional locking means of the molding unit arranged at the front are eliminated.

Such an elimination of the locking means offers advantages, in particular, a reduction of the weight in the front part of the mold, facilitates the opening of the mold as well as the exit of the manufactured container outside of the mold in the open position, and as a result the manufacturing rates are increased.

Advantageously, the compensation gripper is longitudinally retracted rearward when the molding unit is to be opened, and as a result the opening of it is facilitated, and its compactness in the open position is improved.

However, the more compact a molding unit is and the less space it requires in the open position, the more molding units can be installed circumferentially in a rotary machine of a given diameter and, as a corollary, the more the container manufacturing capacities of this machine are increased.

Advantageously, the driving of the compensation gripper by an element of the control mechanism for opening and closing the mold makes it possible to obtain—in a simple and reliable manner—a synchronous control of the compensation during the manufacturing cycle of the container.

Advantageously, the connection during movement of the carriage of said control mechanism for forming the drive means of the compensation gripper such as those of the mold of the bottom makes it possible to optimize the operation as soon as the assembly is controlled by means of one and the same cam.

Most particularly, the synchronization between the opening/closing of the mold and the movement of the gripper, as well as that of the mold of the bottom, is achieved without in particular requiring either complex machining or adjustments or particularly long development efforts.

Advantageously, the determined force that is applied by the actuating means associated with the gripper for obtaining said compensation force is reduced because of the benefit of the amplifying effect corresponding to the lever arm.

As a result of which, for the same compensation force, the compensation means according to the invention offer in use a better energy yield than those of a compensation chamber according to the state of the art.

Advantageously, the compressed air that is used when the actuating means associated with the gripper consist of at least one pneumatic cylinder is at least partially recycled after each compensation cycle for the purpose of reuse.

According to other characteristics of the invention:
Said compensation force applied by the gripper on each of the mold carriers is a thrust force that is applied along a median transverse plane that is orthogonal to the parting line and that passes through the main axis of the mold;
Said gripper comprises two levers, at least one of which is mounted to move around articulation means respectively between at least one separated position and one clamped position in which, with the mold occupying said closed position, said gripper applies on the mold carriers said compensation force so as to clamp them against one another;
The articulation means of the gripper are arranged longitudinally on said at least one lever between a rear part and a free front part intended to apply said compensation force in such a way as to form a lever, said to be of the first class;
One of the levers of the gripper is mounted to move in rotation around a vertical pivot and the other of the levers of the gripper is mounted to move in rotation around another vertical pivot in such a way that the two levers of the gripper are mounted to move between the separated position and the clamped position for application of the compensation force;
Said unit comprises actuating means associated with the gripper that are controlled selectively for applying a determined force transversely on the levers of the gripper so as to obtain said compensation force;
The actuating means comprise at least one cylinder, with said cylinder comprising a piston that is mounted to slide in an airtight manner in a bore of a body of the cylinder, where said piston delimits with said bore at least one variable-volume control chamber that can be selectively supplied with pressurized fluid;
The gripper is mounted to move longitudinally in translation relative to the mold, with the gripper being linked in movement to drive means that are controlled for moving said gripper selectively between at least:
   A non-engaged position in which said mold is free to occupy the open position, and
   An engaged position in which at least one portion of the gripper extends around the mold that occupies its closed position.
The levers of the gripper delimit transversely between them, in the separated position, a front opening that is larger than the space requirement of the mold carriers in the closed position in such a way that each lever has—transversely in relation to the mold carrier—determined play, as a result of which the gripper in the separated position is able to be moved longitudinally between said non-engaged and engaged positions without entering into contact with the mold carriers;
Said levers of the gripper are automatically returned by elastic return means toward one of the positions among said separated and clamped positions, and the actuating means control the transverse movement of the levers of the gripper toward the other position among said separated or clamped positions of the gripper;
Said means for driving the gripper in translation between said non-engaged and engaged positions are constituted by said control mechanism for controlling the opening and the closing of the mold;
Said mechanism comprises at least one carriage that is mounted to move longitudinally in translation relative to the frame of the unit that carries the mold and that is connected to said frame by sliding means, with said carriage being controlled in movement by means of an actuating device, respectively between a pulled-back position in which the mold occupies said open position and an advanced position in which the mold occupies said closed position;
Said device for actuating the carriage of the control mechanism of the opening and the closing of the mold is of the type with a cam and cam follower for controlling the sliding of the carriage between said advanced and pulled-back positions;
Said device for actuating the carriage of the control mechanism of the opening and the closing of the mold comprises at least one linear motor;
Each mold carrier is connected to said carriage by means of at least one associated link, a front end of which is integral with the mold carrier and the other rear end of which is linked in movement to the carriage by means of coupling means;
Said coupling means of the cam and roller type comprise, for each of the links, at least one roller that is integral with the rear end of the link and works with a cam that is made in a support that is integral in movement with said carriage, in such a way that the translational moving of the carriage by the actuating device simultaneously entrains that of said cam, which cam passed through by said roller that is integral with the link causes the opening or the closing of the mold;
Said cam comprises at least one first curvilinear segment for controlling the closing or the opening of the mold and a second straight segment for allowing the movement of the gripper, relative to the mold in the closed position, between the non-engaged position and the engaged position.

Advantageously, the molding unit is of the type in which the mold comprises a mold of the bottom of the container that, complementary to said molding elements, is mounted to move vertically in translation between at least one bottom position and one top position by means of the associated drive means, and said drive means associated with the mold of the bottom are linked in movement to the carriage of the control mechanism of the opening and the closing of the mold by means of transmission means in such a way as to control in a synchronous manner the movement of the mold of the bottom with that of the opening and the closing of the mold.

Advantageously, the transmission means comprise at least one connecting rod that is mounted to move in rotation around a transverse shaft that, integral with the frame of the molding unit, is arranged between a first part and a second part of the connecting rod, with the first part of the connecting rod being connected to a support comprised by the drive means of the mold of the bottom, with the second part of the connecting rod comprising a roller that works with a complementary cam that is linked in movement to the carriage of the mechanism.

Other characteristics and advantages of this invention will emerge from reading the detailed description that will follow for the understanding of which reference will be made to the drawings in which:

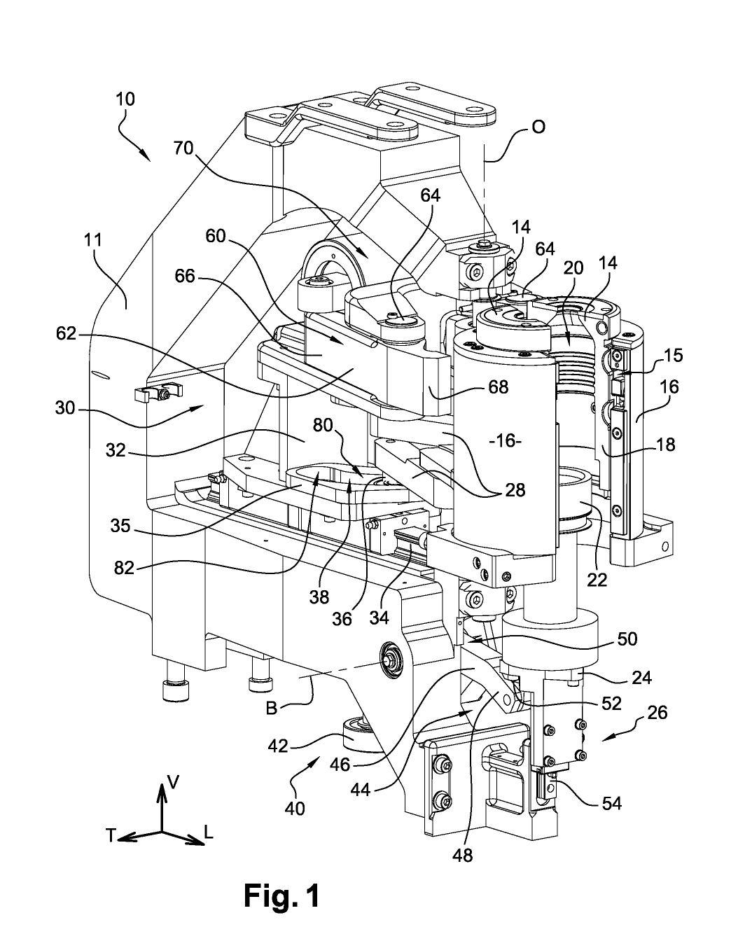

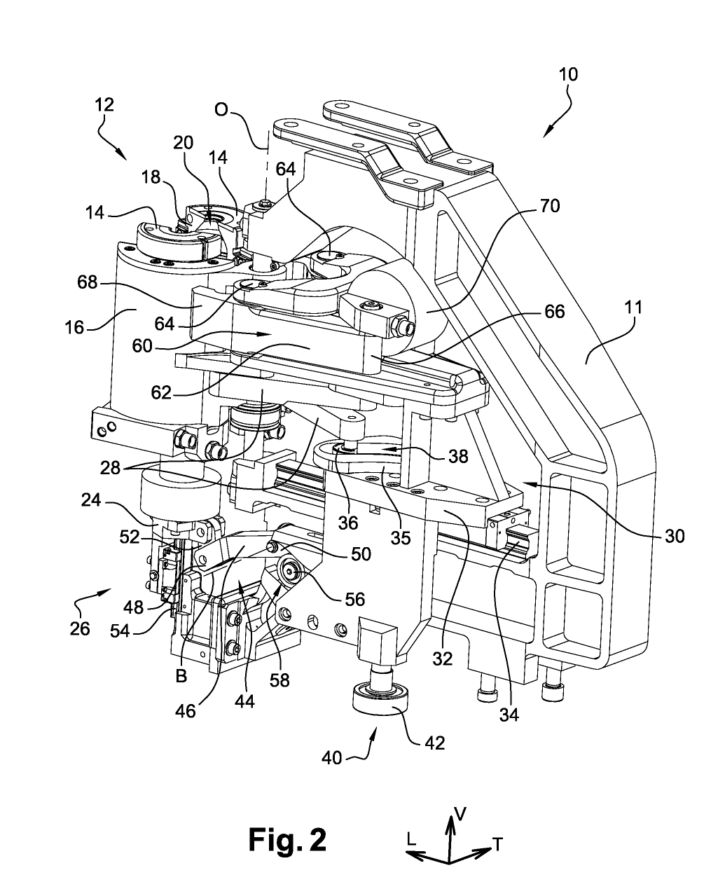

FIGS. 1 and 2 are three-quarter perspective views respectively front and rear that show a molding unit according to an embodiment of the invention and that illustrate the mold of said unit in the open position and the compensation gripper, whose levers are in the separated position, retracted toward the rear in the non-engaged position;

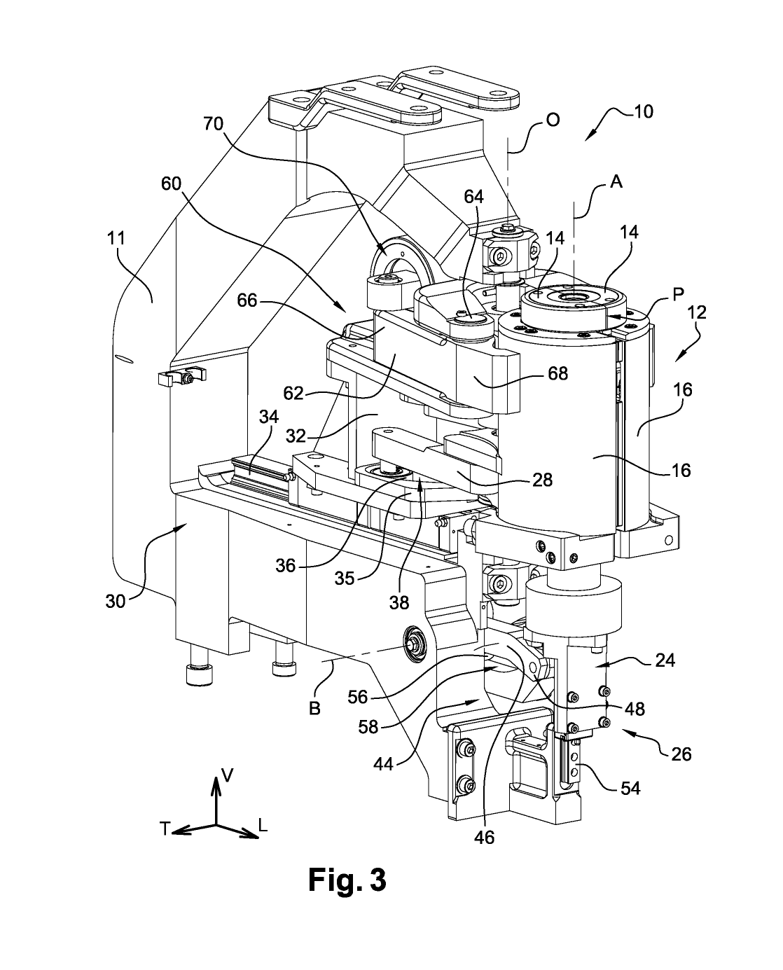

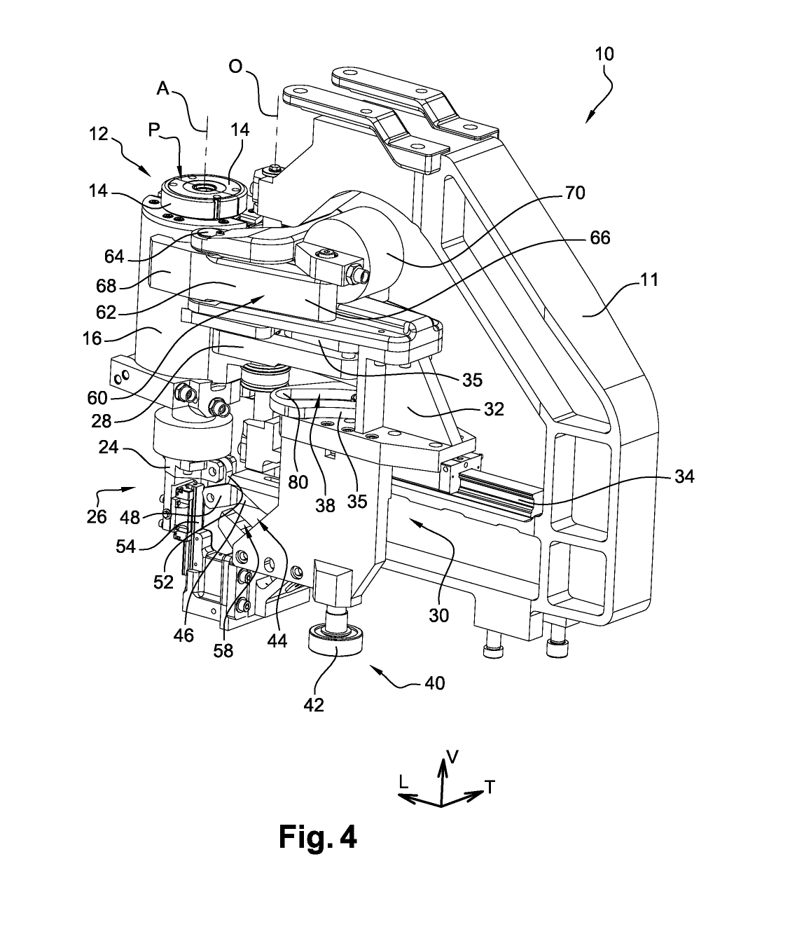

FIGS. 3 and 4 are three-quarter perspective views respectively front and rear that show the molding unit according to FIGS. 1 and 2 and that illustrate the mold of said unit in the closed position and the compensation gripper in the engaged position with the levers in the clamped position for applying the compensation force on the mold carriers;

FIGS. 5 to 8 are diagrammatic representations that show the molding unit according to the embodiment that is illustrated in FIGS. 1 to 4 so as to describe the operation of the assembly during the manufacture of a container with the implementation of compensation.

Conventionally, the longitudinal and transverse directions are determined in a stationary manner relative to the mold carriers in such a way that the open or closed position that is occupied has no impact on said orientations.

In a nonlimiting manner, the terms “front” and “rear” will also be used in reference to the longitudinal orientation, as well as “upper” and “lower” or “top” and “bottom” in reference to the vertical orientation, and finally “left” or “right” and “inside” or “outside” in reference to the transverse orientation.

An embodiment of a molding unit 10 for the manufacture of containers from preforms made of thermoplastic material was shown in FIGS. 1 to 4.

The molding unit 10 according to this example is more particularly intended to be mounted on a machine (not shown) for manufacture of rotary-class containers.

The molding unit 10 comprises a frame 11 by means of which the unit 10 is mounted integrally with a carrousel of the machine that is driven in rotation around a central axis of vertical orientation.

Such a molding unit 10 constitutes one of the molding stations of the machine that comprises a number “n” of molding units, distributed angularly in a uniform manner around and at the periphery of the carrousel of the machine.

The manufacture of containers (bottles, flasks, jars, etc.) made of thermoplastic material, such as PET (polyethylene terephthalate), is carried out in a mold 12 of the molding unit 10 by forming a hot preform.

Preferably, the machine that comprises the molding unit 10 belongs to an installation for manufacture of a container in which said machine, also called “blower,” is associated with a furnace for the thermal conditioning of preforms.

Actually, when the preforms are manufactured in advance by injection molding, the preforms should then subsequently be heated to soften the constituent material before their being formed into containers.

As a variant, the machine is an extrusion-blow-molding machine in which the preform of the container that is made of plastic material is obtained from an extruder, with said hot preform being transformed into a container in the molding unit 10 directly after its manufacture.

The forming of a container from a hot preform is achieved in particular by blow molding or by stretch blow molding by means of at least one pressurized fluid, constituted by, for example, air, with said at least one fluid being introduced through the neck to the interior of the preform placed in the mold 12 of the unit 10.

The molding unit 10 comprises a mold 12 that is carried by the frame 11 of the unit 10. The mold 12 comprises at least two molding elements 14 that are each mounted in an associated mold carrier 16.

The two molding elements 14 are each mounted in a removable manner by means of attachment means 15 in one of the mold carriers 16.

Conventionally, the first molding element 14 is mounted in a first mold carrier 16 that is located to the right of FIG. 1 and the second molding element 14 in a second mold carrier 16 located transversely opposite, on the left of FIG. 1.

At least one of the mold carriers 16 is mounted to move in rotation in relation to the other mold carrier around an axis O of rotation.

Preferably, the two mold carriers 16 are mounted to move in rotation around said axis O of rotation, which axis (O) of rotation extends here vertically along the trihedron (L, V, T).

According to the embodiment of the molding unit 10 that is illustrated by FIGS. 1 to 4, the mold carriers 16 are mounted to move between at least one open position and one closed position of the mold 12.

The open position (FIGS. 1 and 2) of the mold 12 of the unit 10 corresponds to a position in which in particular a hot preform is able to be inserted into the mold for the purpose of its transformation into a container or else a manufactured container is able to be extracted from the mold 12.

The closed position (FIGS. 3 and 4) of the mold 12 of the unit 10 corresponds to a position in which the molding elements 14 are joined against one another by respective support faces 18 that define a parting line P, with said parting line P extending vertically according to a longitudinal orientation along the trihedron (L, V, T).

In the closed position of the mold 12, said at least two molding elements 14 together delimit a molding cavity 20 corresponding to the final container to be manufactured and to the mating of at least two impressions made recessed in said at least two molding elements 14.

In the embodiment illustrated by FIGS. 1 to 4, the mold 12 is made of three complementary molding elements, such a mold design being adopted in particular to form a bottom of complex shape of a container and to facilitate the demolding of the container.

The mold 12 comprises a mold 22 of the bottom of the container that, forming a third complementary element of said molding elements 14, is intended to form the bottom of the container and in this regard is also called “mold bottom.”

The mold 22 of the bottom is mounted on a movable support 24, for example a carriage, which is associated with drive means 26, as a result of which said mold 22 of the bottom is moved vertically between at least one bottom position and one top position.

The drive means 26 control the movement of the support and of said mold 22 of the bottom by synchronization with the other molding elements 14 of the mold 12.

The drive means 26 of the support 24 of the mold 22 of the bottom move the mold 22 of the bottom between at least the bottom position that is occupied when the mold 12 is in the open position and the top position that is occupied in the closed position of the mold and in which the molding elements 14 clamp said mold 22 of the bottom for manufacturing the container.

The molding unit 10 comprises forming means (not shown) for the introduction inside the preform of at least one pressurized fluid for the purpose of the molding of the corresponding container in the cavity 20 of the mold 12.

Such means of forming by blow molding or stretch blow molding in particular are mounted on the top part of the frame 11 of the molding unit 10, perpendicular to the mold 12.

Reference will be made to, for example, the document FR-2,764,544 for more ample details on the above-mentioned blow molding means or stretch blow molding means, also sometimes called—and produced in the form of—a blow molding nozzle.

At least one of the mold carriers 16 comprises at least one link 28 by means of which said mold carrier 16 is moved between the open and closed positions of the mold 12.

The molding unit 10 comprises a mechanism 30 for controlling the opening and the closing of the mold 12 for selectively controlling the movement of at least one of the mold carriers 16, here the two mold carriers 16, between said open and closed positions of the mold 12.

The control mechanism 30 is of the type in which the opening or the closing of the mold 12 is achieved by at least one element that, mounted to move in translation in the longitudinal direction, works with said at least one link 28 that is connected to each mold carrier 16 to bring about the movement between the open and closed positions.

The element of the control mechanism 30 is formed by a carriage 32 that is mounted to move longitudinally in translation relative to the frame 11 of the unit 10 that carries the mold 12.

The carriage 32 is connected to the frame 11 by means of sliding means 34 owing to which the carriage 32 slides longitudinally from the rear to the front and vice versa.

The sliding means 34 associated with the movable carriage 32 consist of, for example, at least one slide that is integral with the frame 11 of the molding unit 10.

Each mold carrier 16 is connected to said carriage 32 by means of at least one associated link 28, a front end of which is integral with the mold carrier and the other rear end of which is linked in movement to the carriage 32 forming the movable element of the mechanism 30.

The mechanism 30 comprises coupling means that are involved in linking said mold carriers 16 in movement to the carriage 32 by means of the links 28.

Preferably, the coupling means consist of a cam and roller control system that links in movement, by means of the links 28, said mold carriers 16 to the carriage 32 in such a way that the longitudinal movement of the carriage 32 brings about the opening or the closing of the mold 12.

The coupling means comprise at least one roller 36 that is integral with the rear end of said at least one link 28 and works with a cam 38 that is made in a support 35 that is integral in movement with said carriage 32.

The carriage 32 is respectively mounted to move between at least a pulled-back position and an advanced position.

The pulled-back position of the carriage 32 corresponds to a position in which the mold 12 occupies the open position, and the advanced position of the carriage 32 corresponds to a position in which the mold 12 occupies the closed position.

The carriage 32 is controlled in movement between said pulled-back and advanced positions by means of an actuating device 40 of said carriage 32 of the control mechanism 30 of the opening and the closing of the mold 12.

Preferably, the actuating device 40 is of the cam and cam follower class for selectively controlling the sliding of the carriage 32 between said advanced and pulled-back positions and by so doing the opening or the closing of the mold 12.

The actuating device 40 comprises at least one roller 42 that, integral in movement with said carriage 32, forms said cam follower.

The roller 42 is intended to pass through a cam (not shown) that the molding machine, equipped with the molding unit 10, comprises when said molding unit 10, integral by its frame 11 with a carrousel of such a machine, is driven by a rotational movement relative to said cam.

As a variant, said device 40 for actuating the carriage 32 of the control mechanism 30 of the opening and the closing of the mold 12 comprises at least one actuator that is able to act on the carriage 32 so as to control its sliding between said advanced and pulled-back positions.

Such an actuator that is associated with the carriage 32 is formed by, for example, a double-action cylinder or else a linear electric motor, with said actuator preferably acting on at least one drive element that is integral with the carriage 32 or as a variant directly on the carriage 32.

According to a preferred variant, said device 40 for actuating the carriage 32 of the control mechanism 30 of the opening and the closing of the mold 12 comprises at least one linear motor.

By comparison with a mechanical actuation of the cam and cam follower class, a linear motor requires in particular no greasing, thus eliminating any regular maintenance and eliminating the risks that are associated with fouling in the near environment of the mold.

Advantageously, the use of a linear motor as an actuating device 40 makes it possible to obtain a better resumption of force, a more precise actuation, and a very good repeatability.

Advantageously, the operational parameters of the linear motor are able to be modified easily and quickly, in particular if a change in application for the manufacture of another container requires it.

The translational movement of the carriage 32 by said actuating device 40 simultaneously drives that of the cam 38, which cam 38 is then passed through by the roller 36 that is integral with the link 28 that then causes the opening or the closing of the mold in the direction of longitudinal movement of the carriage 32 between its pulled-back and advanced positions.

In the embodiment, said means 26 for driving the mold 22 from the bottom of the container consist of the control mechanism 30 of the opening and the closing of the mold 12 and more particularly the actuating device 40.

To carry out the driving of the bottom mold 22, transmission means 44 are used to link in movement the support 24 of the bottom mold 22 to the carriage 32 of the mechanism 30.

Advantageously, the vertical movement of the mold 22 of the bottom is controlled synchronously with that of the opening and the closing of the mold 12.

With the carriage 32 of the mechanism 30 ensuring the driving of the support 24, it is not necessary to provide independent drive means 26 associated with the support 24 of the mold 22 of the bottom to control the vertical movement thereof between said bottom and top positions.

As a variant, the drive means 26 of the mold 22 of the bottom are formed by independent means of the control mechanism 30 of the opening and the closing of the mold 12, with such drive means 26 being controlled separately but by synchronization with the opening or the closing of the mold 12 of the unit 10.

Preferably, the transmission means 44 comprise at least one connecting rod 46 that is mounted to move in rotation around a transverse shaft B that, integral with the frame 11 of the molding unit 10, is arranged between a first part 48 and a second part 50 of said connecting rod 46.

The first front longitudinal part 48 of the connecting rod 46 is connected to the support 24 of the mold 22 of the bottom, for example here by means of a link 52, one end of which is linked to the support 24 and the other end of which is linked to said first part 48 of the connecting rod 46.

The link 52 that is associated with the connecting rod 46 ensures the transformation of the rotational movement of the connecting rod 46 around said shaft B in a vertical movement of the support 24 that is mounted to slide relative to the frame 11, for example by means of a slide 54.

The second rear longitudinal part 50 of the connecting rod 46 comprises a roller 56, here offset transversely, which works with a complementary cam 58 that is linked in movement to the carriage 32 of the mechanism 30.

The longitudinal translational movement of the carriage 32 between the pulled-back and advanced positions drives in movement said cam 58 that, by working with the roller 56, controls the rotation of the connecting rod 46 around said shaft B.

The movement of the connecting rod 46 controlled by the cam 58 causes, according to the direction of movement of the carriage 32, the rise or fall of said support 24 of the mold 22 of the bottom, respectively between said bottom and top positions of said mold 22 of the bottom.

The molding unit 10 comprises compensation means 60 that are controlled selectively for exerting a compensation force E, tending to clamp against one another the molding elements 14 in the area of said parting line P and in opposing the forces that the pressurized fluid applies on the molding elements 14 during the molding of a container from a preform.

The compensation means 60 are formed by at least one gripper that acts on the mold carriers 16 to clamp them against one another in the closed position of the molding unit 10 and to apply said compensation force E.

The compensation means are formed by at least one gripper 60, preferably in the embodiment a gripper 60. As a variant, the compensation means are formed by at least two grippers that are, for example, superposed vertically and arranged for opening in the same direction.

Advantageously, said compensation force E that is applied by the gripper 60 on each of the mold carriers 16 is a thrust force that is applied along a median transverse plane that is orthogonal to the parting line P and that passes through the main shaft A of the mold 12.

The main shaft A of the mold 12 extends vertically and is aligned in the longitudinal direction with the axis O of rotation of the mold carriers 16 of the mold 12.

As a variant, said compensation force E is applied by the gripper 60 circumferentially over all or part of the external surface of the mold carriers 16, for example a curvilinear portion.

The gripper 60 forming the compensation means is controlled selectively between at least a passive state and an active state for compensation in which, with the mold 12 occupying said closed position, said gripper 60 applies on the mold carriers 16 said compensation force E so as to clamp them against one another.

In the embodiment illustrated in FIGS. 1 to 4, the gripper 60 comprises two levers 62, at least one of which is mounted to move around articulation means 64.

Preferably, the two levers 62 of the gripper 60 are mounted to move around articulation means 64, as are also the two mold carriers 16, and not just one of them, mounted to move in relation to one another around the axis O of rotation.

The levers 62 of the gripper 60 are respectively mounted to move between at least one separated position and one clamped position in which, with the mold 12 occupying said closed position, said gripper 60 exerts on the mold carriers said compensation force E so as to clamp them against one another.

The separated position corresponds to the passive state of the compensation means 60 while the clamped position corresponds to the active state.

Preferably, the gripper 60 comprises means 65 for the elastic return of at least one of the levers 62 toward said separated position, here the automatic return of the two levers 62 that are mounted articulated around the articulation means 64.

The elastic return means 65 of the levers 62 consist of, for example, a spring that is inserted between the levers 62 and that acts on said levers 62 toward the separated position of the gripper 60.

The articulation means 64 of the levers 62 of the gripper 60 consist of at least one vertical pivot.

Preferably, the articulation means 64 are arranged longitudinally on said at least one movable lever 62 between a rear part 66 and a free front part 68 intended to apply said compensation force E in such a way as to form a lever, said to be of the first class.

By definition, a lever is said to be of the first class when the shaft is arranged between the point of application of the driving force and the point of application of the resistant force; the Roman scales constitute an example of such a lever of the first class.

As a variant, the articulation means 64 of the gripper 60 consist of at least one vertical pivot that is arranged on the rear part 66 of said at least one lever 62, longitudinally opposite the free front part 68 that is intended to apply said compensation force E in such a way as to form a lever, said to be of the third class.

By definition, a lever is said to be of the third class when the point of application of the driving force is arranged between the shaft and the point of application of the resistance force; a pair of tweezers constitutes an example of such a lever of the third class.

In the embodiment, the two levers 62 of the gripper 60 are mounted to move between said separated position and said clamped position around separate articulation means 64.

One of the levers 62 of the gripper 60 is mounted to move in rotation around a vertical pivot 64 while the other one of the levers 62 of the gripper is mounted to move in rotation around another vertical pivot 64 in such a way that each of the two levers 62 is mounted around an associated pivot.

As a variant, the levers 62 of the gripper 60 are mounted to move in rotation around a pivot that is common to the two levers 62.

The molding unit 10 comprises actuating means 70 associated with the gripper 60 that are controlled selectively for applying a determined force transversely on said rear parts 66 of the levers 62 of the gripper 60 so as to obtain said compensation force for clamping the mold carriers 16 one against the other in the closed position and opposing forces that the pressurized fluid applies on the molding elements 14 during the molding of a container starting from a preform.

As a variant, with a lever of the third class, said molding unit 10 comprises actuating means 70 associated with the gripper 60 that are controlled selectively for applying a determined force transversely on intermediate parts of the levers 62 of the gripper located longitudinally between the articulation means 64 rearward and the free front parts 68 for application of said compensation force.

Advantageously, whether said at least one movable lever 62 of the gripper 60 is of the first or third class, said compensation force applied by the gripper 60 on the mold carriers 16 corresponds to said determined force produced by the actuating means 70, augmented by an effect of the lever arm.

The determined force that is applied transversely by said actuating means 70 on the rear parts 66 of the levers 62 is a thrust force directed from the inside toward the outside.

Such is the case in particular when the actuating means 70 are placed transversely between the rear part 66 of the levers 62 of the gripper 60, when said levers 62 are each mounted to move in rotation around an associated pivot 64, and when the gripper 60 forms a lever of the first class.

As a variant, said determined force applied transversely by said actuating means 70 on the rear parts 66 of the levers 62 is a traction force directed from the inside toward the outside.

Such will be the case in particular when the actuating means 70 are placed transversely on both sides of the rear parts 66 of the levers 62 of a gripper 60 forming a lever of the first class and when said levers 62 are each mounted to move in rotation around a pivot 64.

Based on the arrangement of the actuating means 70 in relation to the levers 62 of the gripper 60, articulation means 64, and the class of lever, the determined force that is applied for obtaining said compensation force is either a thrust force or a traction force.

In the same manner, the direction according to which said determined force is applied transversely is based on the general design of the gripper 60 and the arrangement of the actuating means 70 that are associated with it.

Thus, said determined force applied transversely by said actuating means 70 on the rear parts 66 of the levers 62 is in particular a traction force that will be directed from the inside toward the outside when the actuating means 70 are placed transversely between the rear parts 66 of the levers 62 of a gripper 60 forming a lever of the first class and said levers 62 of which are mounted to move in rotation around a common pivot.

Said determined force applied transversely by said actuating means 70 on the rear parts 66 of the levers 62 will also be a traction force that will be directed from the inside toward the outside when in particular the actuating means 70 are placed transversely between intermediate parts of levers 62 of a gripper forming a lever of the third class, said levers 62 of which are mounted to move in rotation around a common pivot 64.

As a variant, said determined force applied transversely by said actuating means 70 on the rear parts 66 of the levers 62 is a thrust force directed from the inside toward the outside, when said actuating means 70 are placed transversely on both sides of the rear parts 66 of levers 62 of a gripper 60 forming a lever of the first class and the levers 62 of which are mounted to move in rotation around a common pivot 64.

Said determined force will also be a thrust force directed from the inside toward the outside when, with the actuating means 70 being placed transversely on both sides of the intermediate parts of levers 62, the levers 62 are mounted to move in rotation around a common pivot 64 and when the gripper forms a lever of the third class.

Preferably, the actuating means of the gripper 60 comprise at least one cylinder 70.

The cylinder 70 is more particularly shown in diagram form in FIG. 5 ff.

The cylinder 70 comprises a piston 72 that is mounted to slide in an airtight manner in a bore 74 of a body 76 of the cylinder, with said piston 72 delimiting with said bore 74 at least one variable-volume control chamber 78 that can be supplied selectively with pressurized fluid.

Preferably, the levers 62 of the gripper 60 are returned automatically by the elastic return means 65 toward one of the positions from among said separated and clamped positions, here toward the separated position.

The actuating means formed by said at least one cylinder 70 control the transverse movement of the levers 62 of the clamp 60 toward the other position from among said separated or clamped positions of the gripper, consequently here toward the clamped position.

Advantageously, the elastic return means 65 of the levers 62 in the separated position are integrated in said cylinder 70 that is associated with the gripper 60.

As a variant, the elastic return means 65 of the levers 62 in the separated position are independent of the actuating means 70.

In the presence of automatic return means 65 of the levers 62 of the gripper 60 in the separated position, the actuating means advantageously consist of at least one single-action cylinder.

Preferably, the actuating means 70 consist of a pneumatic-type cylinder.

As a variant, the actuating means 70 could, for example, consist of an electric cylinder or any other suitable actuating means.

In the embodiment, the cylinder 70 is arranged transversely between said rear parts 66 of the levers 62 of a gripper forming a lever of the first class and said levers 62 of which are each mounted to move around a separate pivot 64.

The rear part 66 of one of the levers 62 of the gripper 60 is linked in movement to the piston 72 of said cylinder 70, and the rear part 66 of the other of the levers 62 of the gripper 60 is linked in movement to the body 76 of the cylinder 70.

As a variant, the actuating means 70 control the transverse movement of the levers 62 of the compensation gripper 60 around articulation means 64 between said separated position and said clamped position of the gripper and vice versa.

Such will be the case in particular in the absence of elastic return means 65, and the actuating means 70 then consist of, for example, at least one double-action cylinder, in particular of the pneumatic or electric type.

In the embodiment of FIGS. 1 to 4, the gripper 60 is advantageously mounted to move longitudinally in translation relative to the mold 12 of the molding unit 10.

The gripper 60 is linked in movement to drive means that are controlled for moving said gripper 60 longitudinally between at least one non-engaged position and one engaged position.

The non-engaged position of the gripper 60 corresponds to a position in which said mold 12 is free to occupy the open position, and the engaged position corresponds to a position in which at least a portion of the gripper 60 extends around the mold 12 that preferably occupies its closed position.

As a variant, not shown, the gripper 60 is longitudinally stationary relative to the mold 12, and the levers 62 of the gripper 60 are mounted to move in rotation around the articulation means 64, moving transversely between said separated and clamped positions.

Advantageously, the gripper 60 in the separated position is able to be selectively retracted longitudinally rearward by said associated drive means, and as a result, in particular the opening of the mold 12 is facilitated, for example for the purpose of the extraction of the manufactured container.

Advantageously, the retraction of the gripper 60 also makes it possible to improve the general compactness of the molding unit 10 in the open position, which participates in increasing the number of manufactured containers.

The improvement of the compactness of the molding unit 10 in the transverse direction makes it possible most particularly to increase the total number of molding units 10 that can be installed on the carrousel of a machine of a given diameter.

Preferably, the front parts 68 of the levers 62 of the gripper 60 delimit transversely between them, in the separated position, a front opening that is larger than the space requirement of the mold carriers 16 in the closed position.

The separation between the levers 62 is determined to ensure that each lever 62 has transversely, in relation to the mold carrier, determined play “j,” as a result of which the gripper 60 in the separated position is able to be moved longitudinally between said non-engaged and engaged positions without entering into contact with the mold carriers 16.

Thus, any friction between the gripper 60 and the mold carriers 16 during the longitudinal movement of the gripper 60 for the purpose of achieving compensation or after having carried out compensation during the manufacture of the container is avoided.

Advantageously, the drive means in translation of the gripper 60 between said non-engaged and engaged positions consist of said control mechanism 30 for controlling the opening and the closing of the mold 12.

In the embodiment, the drive means in translation of the gripper 60 consist of at least the carriage 32 of said mechanism 30 that is mounted to move longitudinally in translation and that is controlled in movement between said advanced and pulled-back positions by means of the actuating device 40.

Thus, said non-engaged and engaged positions of the gripper 60 correspond respectively to a pulled-back position and to an advanced position of said carriage 32 of the control mechanism 30 of the opening and the closing of the mold.

Advantageously, the driving of the compensation gripper 60 by an element of the control mechanism 30 of the opening and closing of the mold 12, such as the carriage 32, makes it possible to achieve, in a simple and reliable manner, a synchronous control of the installation of the compensation gripper during the manufacturing cycle of the container.

Advantageously, the connection during movement of the carriage 32 of said control mechanism 30 for forming the drive means of the gripper 60 like those of the mold 22 of the bottom makes possible a great simplification such as an optimization of the operation, in particular because of the fact that the assembly is controlled by means of the actuating device 40, in the example by one and the same cam.

Most particularly, the synchronization between the opening or the closing of the mold 12 and the movement of the gripper 60, even also that of the mold 22 of the bottom, is achieved in a simple manner without in particular requiring either complex machining, or adjustments of particularly long development efforts.

With reference to FIGS. 5 to 8, the operation of the molding unit 10 according to the embodiment of FIGS. 1 to 4 during the manufacture of a container with compensation carried out by means of a gripper will now be described in more detail.

In FIG. 5, the mold 12 of the molding unit 10 was shown in the open position, which corresponds to the final position of the mold after the container was extracted and before the following hot preform was inserted for the manufacture of a new container.

The carriage 32 of the control mechanism 30 for opening and closing the mold 12 then occupies its pulled-back position.

The gripper 60 that forms the compensation means is in the non-engaged position, pulled back longitudinally to the rear in relation to the mold 12, and the levers 62 occupy their separated position.

In the embodiment, the levers 62 are automatically returned toward said separated position by the elastic return means 65, with the actuating means 70 being inactive.

The control chamber 78 of the cylinder 70 is not supplied with pressurized fluid so that the levers 62 are not acted upon by the cylinder 70.

The mechanism 30 and its actuating device 40 advantageously constitute the drive means of the gripper 60 that is linked in movement longitudinally to said carriage 32 of the mechanism 30.

For the sake of simplicity, the mold 22 of the bottom is not shown in FIG. 5 ff, but according to the embodiment, the mechanism 30, in particular the carriage 32 and its actuating device 40, advantageously constitutes the drive means thereof.

To carry out the driving, the mold 22 of the bottom is linked in movement to the carriage 32 by means of the transmission means 44 that transform the longitudinal movement of the carriage 32 into a vertical movement, respectively between the bottom and top positions.

The mold 22 of the bottom initially occupies its bottom position when the mold 12 is in the open position.

The first stage consists in initiating the closing of the mold 12 into which a hot preform is inserted, parallel to the closing, to be transformed into a container there, in particular by blow molding or by stretch blow molding.

The molding unit 10 is linked in rotation by means of the frame 11 to the carrousel of the machine and is driven in rotation by said carrousel. The molding unit 10, and more particularly the roller 42 of the actuating means 40 of the carriage 32 of the mechanism 30, passes through a complementary stationary cam (not shown) that the machine comprises.

The cam of the machine is shaped to induce the translational movement in the longitudinal direction of the carriage 32 and by so doing to control the opening or the closing of the mold 12.

A cam (or several cam segments) is placed circumferentially around the axis of rotation of the carrousel of the machine for controlling successively the closing of the mold 12 parallel to the insertion of a hot preform and then, in general slightly before having carried out a complete turn, the opening of the mold 12 so as to make possible the extraction of the container that is obtained.

The cooperation between the roller 42 and the control cam carried by the machine brings about the translational movement of the carriage 32 from its pulled-back position, shown in FIG. 5, to its advanced position, shown in FIG. 6.

The carriage 32 slides longitudinally forward in the direction of the mold 12 by means of the slide 34 that forms the sliding means intended to make possible a relative movement of the carriage 32 in relation to the mold 12 that is supported by the frame 11.

The longitudinally forward movement of the carriage 32 is accompanied by that of the roller 36 of each link 28 that is associated with one of the mold carriers 16; said roller 36 passes through a first curvilinear segment 80 of the cam 38 that is made in the support 35 that is integral with the carriage 32.

As shown in FIGS. 5 to 8, said cam 38 comprises at least a first curvilinear segment 80 for controlling the closing or the opening of the mold and a second straight segment 82 for allowing the movement of the gripper 60, relative to the mold 12 in the closed position, between the non-engaged position and the engaged position.

The longitudinal movement of the carriage 32, from the pulled-back position to the advanced position, brings about the closing of the mold 12 by means of the links 28 whose cooperation between the roller 36 and the first segment 80 of the cam 38 controls the movement.

As can be seen by comparison between FIGS. 5 and 6, the links 28 pass from an inclined position that is illustrated in FIG. 5 and that corresponds to the open position of the mold 12 to a longitudinal position that is illustrated in FIG. 6 and that corresponds to the closed position of the mold 12.

Between the positions illustrated in FIGS. 5 and 6, the roller 36 of each link 38 is moved from one end to the other of the first segment 80 of the cam 38, from the front toward the rear, by bringing about the closing of the mold 12.

The second stage consists in bringing the gripper 60 into the engaged position for the purpose of applying the compensation force.

Of course, such a second stage results because the gripper 60 according to the embodiment is mounted to move longitudinally in relation to the mold 12 between a non-engaged position and an engaged position.

As illustrated in FIG. 6, the mold 12 is closed; however, the gripper 60 has not yet reached its engaged position. The gripper 60 actually occupies an intermediate position between said non-engaged and engaged positions.

The front part 68 of each of the levers 62 of the gripper 60, which remain in the separated position, is only partially engaged around the mold carriers 16 of the closed mold 12.

Preferably, the front parts 68 of the levers 62 of the gripper have between them a transverse separation that is determined in relation to the mold 12 for exhibiting play “j” between each of them and the mold carrier 16 opposite; for this reason, the movement of the gripper 60 toward its engaged position is carried out without said front parts 68 of the levers 62 entering into contact with the mold carriers 16.

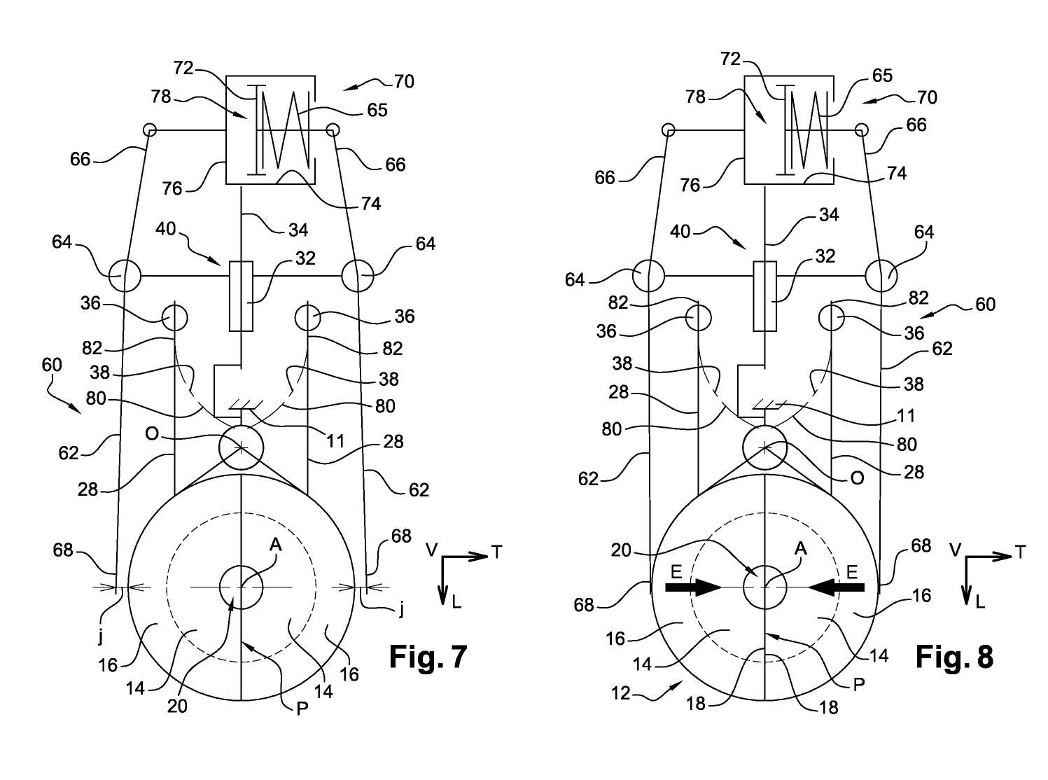

Advantageously, the second straight segment 82 that the cam 38 has makes it possible for the gripper 60 to continue its longitudinal movement forward, relative to the mold 12 that from now on occupies its closed position until reaching its engaged position shown in FIG. 7.

In the engaged position of the gripper 60, the front parts 68 of the levers 62 are positioned in a median transverse plane that is orthogonal to the parting line P and that passes through the main shaft A of the mold 12.

With the gripper 60 being in the engaged position illustrated in FIG. 7, the third stage consists in controlling the actuating means 70 for applying by means of the gripper 60 said compensation force E on the mold carriers 16 of the mold 12 occupying the closed position.

The control chamber 78 of the cylinder 70 is supplied with pressurized fluid, for example by air in the case of a pneumatic cylinder. The pressurization of the chamber 78 brings about the transverse movement of the piston 72 that slides in an airtight manner into the bore 74 of the body 76 of the cylinder 70.

The piston 72 acts on the rear part 66 of one of the levers 62, with the other of the levers 62 being connected to the body 76 of the cylinder 70; the movement of the piston 72 brings about a separation of the rear parts 66 of the levers 62, which move transversely outward.

The piston 72 of the cylinder 70 applies on the rear parts 66 of the levers 62 a determined force that brings about the pivoting of each of the levers 62 around pivots 64 forming articulation means, with the levers 62 passing from the separated position, occupied until then, to the clamped position shown in FIG. 8.

The play j is canceled when said clamped position is reached by the levers 62 of the gripper 60.

The force that is applied on the piston 72 by the pressurized fluid introduced into the control chamber 78 is greater than the elastic return force applied in the opposite direction by the means 65 formed by, for example, a spring that is integrated in the cylinder 70.

In the clamped position, the front parts 68 of the levers 62 apply on the mold carriers 16 a compensation force E shown in FIG. 8 that corresponds, in the embodiment, to the determined force developed by the cylinder 70 that is advantageously augmented by an effect of the lever arm.

The application by the gripper 60 of the compensation force E has the effect of clamping the mold carriers 16 against one another in a closed position in such a way as to eliminate, at the very least to reduce, any play between the support faces 18 of the molding elements 14 of the mold 12 that are mated along the parting line P.

The applied compensation force E first makes possible the cancelation of such play when it initially exists between the molding elements 14.

The intensity of the compensation force E that is obtained owing to the cylinder 70 is primarily determined so that the support faces 18 of the molding elements 14 remain contiguous in the area of the parting line P and so that no play subsequently appears between them during the forming of the hot preform by blow molding or by stretch blow molding for the purpose of obtaining the final container.

Thus, the necessary compensation force E is determined for each application based on the forces that the pressurized fluid that is used for the forming of the container will apply on the surface of the molding elements 14 that delimit the cavity 20.

The forces to which the compensation force E is opposed are in particular based on manufacturing parameters such as the pressure of the blow molding fluid and the application surface of these forces since it varies with the capacity of the container.

The application of the compensation force E advantageously ceases once the hot preform is transformed into a container, and next, in the opposite direction, the stages that were described above are carried out for the purpose of making possible the extraction of the final container.

A fourth stage consists in ceasing to apply on the closed mold 12 the compensation force E by means of the gripper 60.

To do this, the control chamber 78 of the cylinder 70 ceases to be supplied with pressurized fluid; the pressure decreases there until the piston 72 is acted on with a force that is less than that applied by the spring 65 that forms the elastic return means of the levers 62.

The levers 62 of the gripper 60 are returned automatically toward the separated position, and the play “j” between the front parts 68 of the levers 62 and the mold carriers 16 is reestablished in such a way that the molding unit 10 is in a situation that is identical to the one illustrated by the preceding FIG. 7.

A fifth stage consists in retracting the gripper 60 by moving it from its engaged position toward its non-engaged position in such a way as to be able next to initiate the opening of the mold 12.

The carriage 32 is moved longitudinally in translation from the front rearward, from its advanced position toward its pulled-back position, by means of the machine cam that is equipped with the molding unit 10 that controls the movement of the carriage 32 by acting on the roller 42 of the actuating device 40 of said carriage 32.

The roller 36 of each of the links 28 passes through the second straight cam segment 82 in the opposite direction, at the end of which the gripper 60 is disengaged enough to be able to begin the opening of the mold 12, where said opening is controlled by the first segment 80 of the cam 38.

The molding unit 10 is in a situation that is analogous to the one occupied and shown above in FIG. 6.

A sixth stage consists in continuing the movement of the carriage 32 until the latter reaches its pulled-back position for which the mold 12 is in the open position, or in a situation that is analogous to the one shown in FIG. 5.

Advantageously, with the mechanism 30 and the actuating device 40 that is associated with it respectively forming the drive means of the gripper 60 and the mold bottom 22, the carriage 32 of the mechanism drives them, bringing the gripper 60 into the non-engaged position and the mold bottom 22 into the bottom position.

The extraction of the container outside of the molding cavity 20 is carried out during the opening of the mold 12 and, once the latter is achieved, a new hot preform is able to be inserted to begin the manufacture of a new container.

1. Molding unit (10) for the manufacture of containers from preforms made of thermoplastic material, with said molding unit (10) comprising at least:
a frame (11) that carries a mold (12) that comprises at least two molding elements (14), each respectively mounted in an associated mold carrier (16),
at least one of said mold carriers (16) being mounted to move in rotation in relation to the other around a vertical axis (0) of rotation between an open position and a closed position of the mold in which said molding elements (14) are mated with one another by respective support faces (18) defining a longitudinally-oriented vertical parting line (P) and together delimit a molding cavity (20);
forming means for introducing at least one pressurized fluid inside the preform for the purpose of molding the corresponding container in the cavity (20),
a control mechanism (30) of the opening and the closing of the mold (12) for controlling the movement of at least one of the mold carriers (16) between said open and closed positions of the mold,
and selectively controlled compensation means (60) for applying a compensation force, tending to clamp the molding elements (14) against one another in the area of said parting line (P) and to oppose the forces that the pressurized fluid applies on the molding elements (14) during the molding of a container from a preform,
wherein said compensation means are formed by at least one gripper (60) that acts on the mold carriers (16) to clamp them against one another in the closed position of the molding unit (10) and to apply said compensation force.

2. Molding unit according to claim 1, wherein said compensation force that is applied by the gripper (60) on each of the mold carriers (16) is a thrust force that is applied along a median transverse plane that is orthogonal to the parting line (P) and that passes through the primary axis (A) of the mold (12).

3. Molding unit according to claim 1, wherein said gripper (60) comprises two levers (62), at least one of which is mounted to move around articulation means (64) respectively between at least one separated position and one clamped position in which, with the mold (12) occupying said closed position, said gripper (60) applies on the mold carriers (16) said compensation force so as to clamp them against one another.

4. Molding unit according to claim 3, wherein the articulation means (64) of the gripper (60) are arranged longitudinally on said at least one lever (62) between a rear part (66) and a free front part (68) designed to apply said compensation force in such a way as to form a lever, said to be of the first class.

5. Molding unit according to claim 4, wherein one of the levers (62) of the gripper (60) is mounted to move in rotation around a vertical pivot (64) and wherein the other of the levers (62) of the gripper (60) is mounted to move in rotation around another vertical pivot (64) in such a way that the two levers (62) of the gripper (60) are mounted to move between the separated position and the clamped position for application of the compensation force.

6. Molding unit according to claim 1, wherein said unit (10) comprises actuating means (70) that are associated with the gripper (60) that are controlled selectively for applying transversely a determined force on the levers (62) of the gripper (60) so as to obtain said compensation force.

7. Molding unit according to claim 6, wherein the actuating means (70) comprise at least one cylinder, with said cylinder (70) comprising a piston (72) that is mounted to slide in an airtight manner into a bore (74) of a body (76) of the cylinder, with said piston (72) delimiting with said bore (74) at least one variable-volume control chamber (78) that can be supplied selectively with pressurized fluid.

8. Molding unit according to claim 1, wherein the gripper (60) is mounted to move longitudinally in translation relative to the mold (12), with the gripper (60) being linked in movement to drive means that are controlled for selectively moving said gripper (60) between at least:
a non-engaged position in which said mold (12) is free to occupy the open position, and
an engaged position in which at least a portion of the gripper (60) extends around the mold (12) that occupies its closed position.

9. Molding unit according to claim 8, wherein the gripper comprises two levers (62), at least one of which is mounted to move around articulation means (64) respectively between at least one separated position and one clamped position in which, with the mold (12) occupying said closed position, said gripper (60) applies on the mold carriers (16) said compensation force so as to clamp them against one another, and the levers delimit transversely between them, in the separated position, a front opening that is larger than the space requirement of the mold carriers (16) in the closed position in such a way that each lever (62) has—transversely relative to the mold carrier (16)—determined play (j), as a result of which the gripper (60) in the separated position is able to be moved longitudinally between said non-engaged and engaged positions without entering into contact with the mold carriers (16).

10. Molding unit according to claim 6, wherein said levers (62) of the gripper (60) are returned automatically by elastic return means (65) toward one of the positions among said separated and clamped positions and wherein the actuating means (70) control the transverse movement of the levers (62) of the gripper (60) toward the other position among said separated or clamped positions of the gripper.

11. Molding unit according to claim 8, wherein said drive means in translation of the gripper (60) between said non-engaged and engaged positions consist of said control mechanism (30) for controlling the opening and the closing of the mold (12).

12. Molding unit according to claim 11, wherein said mechanism (30) comprises at least one carriage (32) that is mounted to move longitudinally in translation relative to the frame (11) of the unit that carries the mold (12) and that is connected to said frame (11) by means of sliding means (34), with said carriage (32) being controlled in movement by means of an actuating device (40), respectively between a pulled-back position in which the mold (12) occupies said open position and an advanced position in which the mold (12) occupies said closed position.

13. Molding unit according to claim 12, wherein said device (40) for actuating the carriage of the control mechanism of the opening and the closing of the mold (12) is of the type with a cam and cam follower for controlling the sliding of the carriage (32) between said advanced and pulled-back positions.

14. Molding unit according to claim 12, wherein said device (40) for actuating the carriage (32) of the control mechanism (30) of the opening and the closing of the mold (12) comprises at least one linear motor.

15. Molding unit according to claim 11, wherein each mold carrier (16) is connected to said carriage (32) by means of at least one associated link (28), a front end of which is integral with the mold carrier (16) and the other rear end of which is linked in movement to the carriage (32) by coupling means (36, 38).

16. Molding unit according to claim 15, wherein the coupling means of the cam and roller type comprise, for each of the links (28), at least one roller (36) that is integral with the rear end of the link (28) and works with a cam (38) that is made in a support (35) that is integral in movement with said carriage (32), in such a way that the translational moving of the carriage (32) by the actuating device (40) simultaneously entrains that of said cam (38), which cam (38) passed through by said roller (36) that is integral with the link (28) causes the opening or the closing of the mold (12).

17. Molding unit according to claim 16, wherein said cam (38) comprises at least a first curvilinear segment (80) for controlling the closing or the opening of the mold (12) and a second straight segment (82) for allowing the movement of the gripper (60), relative to the mold (12) in the closed position, between the non-engaged position and the engaged position.

18. Molding unit according to claim 11, in which the mold (12) comprises a mold (22) of the bottom of the container that, complementary to said molding elements (14), is mounted to move vertically in translation between at least a bottom position and a top position by means of the associated drive means (26),
wherein said drive means (26) that are associated with the mold (22) of the bottom are linked in movement to the carriage (32) of the mechanism (30) for controlling the opening and the closing of the mold (12) by means of the transmission means (44) in such a way as to control in a synchronous manner the movement of the mold (22) of the bottom with that of the opening and the closing of the mold (12).

19. Molding unit according to claim 16, wherein the transmission means (44) comprise at least one connecting rod (46) that is mounted to move in rotation around a transverse shaft (B) that, integral with the frame (11) of the molding unit (10), is arranged between a first part (48) and a second part (50) of the connecting rod (46), with the first part (48) of the link (46) being connected to a support (24) that the drive means (26) of the mold of the bottom comprise, and with the second part (50) of the connecting rod (46) comprising a roller (56) that works with a complementary cam (58) that is linked in movement to the carriage (32) of the mechanism (30).

20. Molding unit according to claim 2, wherein said gripper (60) comprises two levers (62), at least one of which is mounted to move around articulation means (64) respectively between at least one separated position and one clamped position in which, with the mold (12) occupying said closed position, said gripper (60) applies on the mold carriers (16) said compensation force so as to clamp them against one another.
